(19) United States
(12) Patent Application Publication
(10) Pub. No.: US 2018/0215644 A1
(43) Pub. Date: Aug. 2, 2018

(54) METHOD OF MAKING HOLLOW GLASS MICROSPHERES

(71) Applicant: 3M INNOVATIVE PROPERTIES COMPANY, St. Paul, MN (US)

(72) Inventors: Marcel Doering, Rhede (DE); Stefan V. Friedrich, Kastl (DE); Bernd Gangnus, Herrsching (DE); Klaus Hintzer, Kastl (DE); Gang Qi, Stillwater, MN (US); Friedrich M. Wolff, Burghausen (DE); Tilman C. Zipplies, Burghausen (DE); Blake E. Chandler, Woodbury, MN (US)

(21) Appl. No.: 15/756,854

(22) PCT Filed: Sep. 2, 2016
(86) PCT No.: PCT/US2016/050063

§ 371 Date: Mar. 1, 2018

Related U.S. Application Data
(60) Provisional application No. 62/214,313, filed on Sep. 4, 2015.

(51) Int. Cl. C03B 19/10; C03C 3/089; C03C 3/087

(52) U.S. Cl. CPC C03B 19/107; C03C 3/087; C03C 3/089

(57) ABSTRACT

Provided are methods of manufacturing hollow glass microspheres where a feed composition comprising a glass powder and a blowing agent entrained in the glass powder is introduced into an opening at a first end of a vertically-aligned furnace. Agglomerated glass, unmelted oxides, or natural glassy materials can be used in place of, or in addition to, the glass powder in the feed composition.

### FIELD OF THE INVENTION

The present invention relates to methods of producing hollow glass microspheres. More particularly, these methods produce hollow glass microspheres useful in applications as modifiers, enhancers, rigidifiers, and/or fillers.

### BACKGROUND

Hollow glass microspheres (“HGMs”), also referred to as “glass bubbles,” are balloon-like glass structures having a median diameter of less than 500 micrometers. HGMs are currently made using a process where a milled glass powder (or “glass frit”) that contains a suitable blowing agent is flame-heated to temperatures at which the glass begins to soften. At these temperatures, the blowing agent either becomes or produces a gas, causing the glass powder to expand and form the HGMs. HGM can be made very strong to avoid being crushed or broken during further processing—i.e., mixing, spraying, kneading, molding, extrusion, and the like. Their strength is commonly measured as isostatic collapse strength, which represents the value at which 80% of the HGMs survive an applied isostatic pressure. The collapse strength of HGMs can vary significantly depending on their density—lower density bubbles generally tend to have lower collapse strength and higher density bubbles tend to have higher collapse strength. It is generally desirable to have a balance of high strength at the lowest possible density. Commercial types, e.g. those available from 3M under the trade designation “3M™ Glass Bubbles”, can display a collapse strength from 1.5 MPa to 200 MPa and densities from 0.1 g/cm³ to 0.6 g/cm³.

HGMs have widespread applications in many technologies, including buoyancy modules, density modifiers for drilling fluids, cements, explosives, thermosets (including adhesives and coatings), molded polymeric products (e.g. rubber and thermoplastic parts), and thermal insulation including cryogenic or heat applications, for example, in pipes, tanks or buildings Despite the multitude and size of the markets into which HGMs have penetrated, there are many more application fields for which HGMs could offer a technical solution. Unfortunately, however, these solutions are often not commercially viable due to associated manufacturing costs.

### SUMMARY

There are many technical challenges encountered in the manufacture of HGMs. Commercial glass bubbles are generally formed using flame forming technology. It is believed that the very short residence times in the hot gas flames increase overall HGM yields by avoiding overheating, which results in burst bubbles due to the lower melt viscosity and simultaneously higher pressure from the blowing agent. Amorphous glass compositions used as a feed unavoidably comprise a distribution of particle sizes—the smaller particles will heat up faster than larger particles, so a variety of ideal conditions exist to forming a bubble. By employing very high temperatures in gas flame followed by a rapid quench when the particles leave the flame all particles of the distribution are heated up fast enough to reach the forming temperature, almost simultaneously. While the smaller ones still might reach a higher melt temperature the avoidance of an excessively high number of burst bubbles becomes a question of kinetic control, as the flow processes during expansion take some time. If the quench now comes fast enough the HGM will solidify before it can burst.

Attempts to form monocellular HGMs from a feed comprising a blowing agent using electrical furnaces were not successful because the short residence times used in a flame forming process could not be attained. That lack of control on the time scale means that forming conditions can only be optimal for a part of the particle size distribution, so HGM yields tend to be low.

To overcome the delicate balance between glass melt viscosity and pressure build up by the blowing agent a process employing an electrical furnace was described that forms HGM from a feed without added physical blowing agents and replacing the internal pressure from the blowing agent by an external pressure difference using a vacuum such as described in U.S. Pat. No. 8,261,577 (Qi). This process, however, is difficult with respect to productivity and is difficult for scale-up to large scale production due to the technical complexity of the vacuum requirements.

Current cost to generate HGMs are quite high due to the specific and costly flame forming technology employed to manufacture them and due to the immense energy cost these flame formers entail. The apparatus used to prepare HGMs in the conventional manner is well known in the art. Such apparatus are similar to those described in U.S. Pat. No. 3,230,064 (Alford et al.) and U.S. Pat. No. 3,129,086 (Veatch et al.).

The energy consumption required to manufacture HGMs, as described in Examples 1-4 of U.S. Pat. No. 4,391,646 (Howell), can range from about 8 to about 50 kW-h per kg of product made. While commercial processes operating at a larger scale are more efficient, they still tend to use more than 5 kW-h per kg of product. Provided here are improved energy efficient processes for producing HGMs having high strength-to-density ratios in comparison with current commercial offerings at significantly lower cost.

According to a first aspect, a method of manufacturing hollow glass microspheres is provided. The method comprises: introducing a feed composition comprising a glass powder and a blowing agent entrained in the glass powder into an opening at a first end of a vertically-aligned furnace, whereby the glass powder passes through a series of individually-adjustable heating zones located within the furnace; within at least one heating zone, heating the glass powder to a forming temperature at which the glass powder is softened; thereafter thermally activating the chemical blowing agent to expand the softened glass powder in the feed composition and to obtain the hollow glass microspheres; and discharging the hollow glass microspheres through an opening at a second end of the furnace located distal to the first end.

According to a second aspect, a method of making hollow glass microspheres is provided, comprising: introducing a feed composition comprising an agglomerate comprising glass powder and a blowing agent into an opening at a first end of a vertically-aligned furnace, whereby the agglomerate passes through a series of individually-adjustable heating zones located within the furnace; within at least one heating zone, heating the agglomerate to a forming temperature at which the agglomerate is softened; thereafter thermally activating the chemical blowing agent to expand the softened agglomerate in the feed composition and to obtain the hollow glass microspheres; and discharging the hollow glass microspheres through an opening at a second end of the furnace located distal to the first end.

According to a third aspect, the aforementioned agglomerate comprises a mixture of natural glassy minerals (e.g., perlite, obsidian, basalt) and a chemical blowing agent.

According to a fourth aspect, the aforementioned agglomerate is comprised of natural glassy minerals, a blowing agent and one or more other additives selected from fluxing agents, glass formers, network modifiers, and mixtures thereof.

According to a fifth aspect, the aforementioned agglomerate is comprised of one or more unmelted oxides and a blowing agent.

### BRIEF DESCRIPTION OF THE DRAWINGS

FIG. 1 is a schematic showing a feeding system used in methods of making hollow glass microspheres according to an exemplary embodiment; and

FIG. 2 is a schematic showing a furnace used in methods of making hollow glass microspheres according to an exemplary embodiment.

FIG. 3 is a schematic showing the vertical apparatus used to produce Examples 3-8.

FIG. 4 is an SEM micrograph of the bubbles formed in Example 3.

FIG. 5 is an SEM micrograph of the bubbles formed in Example 4.

FIG. 6 is an SEM micrograph of the bubbles formed in Example 5.

FIG. 7 is an SEM micrograph of the bubbles formed in Example 6.

FIG. 8 is an SEM micrograph of the bubbles formed in Example 7.

FIG. 9 is an SEM micrograph of the bubbles formed in Example 8.

### DEFINITIONS

As used herein:

“average density” is the quotient obtained by dividing the mass of a sample of hollow glass microspheres by the true volume of that mass of hollow glass microspheres as measured by a gas pycnometer. “True volume” is the aggregate total volume of the glass bubbles (not the bulk volume);

“glass” refers to all synthetic amorphous inorganic solids or melts that can be used to form amorphous solids, where the raw materials used to form such glass includes various oxides and minerals;

“HGM” refers to predominantly mono-cellular hollow glass microspheres;

“mono-cellular” means that a given microsphere is defined by only one outer wall, with no additional walls, partial spheres or concentric spheres, or the like present in the microsphere;

“natural glassy mineral” refers to an amorphous inorganic solid of natural, i.e., volcanic origin such as perlite, obsidian, or basalt;

“recycled glass” refers to materials formed using glass as the raw material; and

“softening” of glass refers to the Littleton softening point which is defined as temperature where the glass has a viscosity of 10^{6.6} Pa-s.

### DETAILED DESCRIPTION

Useful methods of making hollow glass microspheres are described herein by way of illustration and example. Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. Figures may not be drawn to scale.

### Glass Feed Compositions

According to the provided methods, HGMs are prepared by passing a feed composition through a vertically-aligned furnace. Useful feed compositions include glass powders. Such glass powders may be prepared, for example, by crushing and/or milling a suitable glassy material, typically a relatively low melting silicate glass containing a suitable amount of blowing agent.

The feed composition may be prepared by crushing and/or milling any glass composition known to be suitable for HGMs. Suitable glass compositions include, for example, silicate glass, borosilicate glass, soda-lime-glass or aluminosilicate glass, including recycled glass and mixtures thereof. Especially useful silicate glass compositions are described, for example, in U.S. Patent Publication No. 2006/0122049 (Marshall et al.) and 2011/0152056 (Qi), and U.S. Pat. No. 2,978,340 (Veatch et al.); U.S. Pat. No. 3,030,215 (Veatch et al.); U.S. Pat. No. 3,129,086 (Veatch et al.); and U.S. Pat. No. 3,230,064 (Veatch et al.); U.S. Pat. No. 3,365,315 (Beck et al.); U.S. Pat. No. 4,391,646 (Howell); U.S. Pat. No. 4,767,726 (Marshall); and U.S. Pat. No. 9,006,302 (Amos et al.).

A typical synthetic glass composition based on total weight can include from 50 to 90 percent of SiO₂, from 2 to 20 percent of alkali metal oxide, from 1 to 30 percent of B₂O₃, from 0.005 to 0.5 percent of sulfur (e.g., elemental sulfur, sulfate or sulfite), from 0 to 25 percent divalent metal oxides (e.g., CaO, MgO, BaO, SrO, ZnO, or PbO), from 0 to 10 percent of tetravalent metal oxides other than SiO₂ (e.g., TiO₂, MnO₂, or ZrO₂), from 0 to 20 percent of trivalent metal oxides (e.g., Al₂O₃, Fe₂O₃, or Sb₂O₃), from 0 to 10 percent of oxides of pentavalent atoms (e.g., P₂O₅ or V₂O₅), and from 0 to 5 percent fluorine (as fluoride) which can act as a fluxing agent to facilitate melting of the glass composition. Additional ingredients are useful in feed compositions and can be included in the powder, for example, to contribute particular properties or characteristics (e.g. hardness or color) to the resultant glass microspheres.

In some embodiments, the glass composition contains more alkaline earth metal oxide than alkali metal oxide. In some of these embodiments, the weight ratio of alkaline earth metal oxide to alkali metal oxide is from 1.2:1 to 3:1. In some embodiments, the glass composition comprises B₂O₃ in a range from 2 percent to 10 percent based on the total weight of the composition. In some embodiments, the composition has up to 10 percent by weight Al₂O₃, based on the total weight of the composition. In some embodiments, the composition is essentially free of Al₂O₃. Here, “essentially free of Al₂O₃” may mean at most 5, 4, 3, 2, 1, 0.75, 0.5, 0.25, or 0.1 percent by weight Al₂O₃. Compositions that are “essentially free of Al₂O₃” also include those having no Al₂O₃.

Instead of, or in combination with, the glass powder, the feed composition could include an agglomerate consisting of glass, a chemical blowing agent and optionally additives like fluxing agents, glass formers and/or network modifiers, including, but not limited to, CaF₂, MgO, BaO, Li₂O, ZnO, B₂O₃, P₂O₅, ZnO, CaO, Na₂O, Al₂O₃ and SiO₂. The glass forming components of the agglomerate can have the same elemental composition as the above mentioned glass composition. The agglomerate could include, in some cases, some amount of sulfates.

Instead of, or in combination with, the glass powder, the feed composition could include an agglomerate of one or more natural glass materials, including for example perlite, obsidian, or basalt, and a chemical blowing agent. As another possibility, the feed composition could use a physical blowing agent, such as entrained water, while containing one or more optional additives such as a fluxing agent, glass former, and/or network modifier as described above. Of course, these optional additives can also be used with agglomerates of natural glass materials that contain a chemical blowing agent.

In other embodiments, the feed composition can include an agglomerate of one or more raw, unmelted oxides, such as a silica or carbonate, suitably mixed with a blowing agent. Such a blowing agent could be either a chemical or physical blowing agent. These oxide agglomerates can later become melted in the furnace during the process of forming glass microspheres.

In preferred embodiments, at least 90 percent by weight of the feed composition has from 70 percent to 80 percent SiO₂ by weight, from 8 percent to 15 percent R¹O by weight; from 3 percent to 8 percent R²₂O by weight; and from 2 percent to 6 percent B₂O₃ by weight relative to the overall weight of the feed composition, where R¹ and R² are metals having the indicated valence. For example, the feed composition could have between 70 percent and 80 percent SiO₂ by weight, 8 percent and 15 percent CaO by weight; 3 percent and 8 percent Na₂O by weight; and 2 percent and 6 percent B₂O₃ by weight.

In preferred embodiments, at least 90 percent, 94 percent, or even at least 97 percent of the feed composition by weight comprises 70 percent to 80 percent SiO₂ by weight, 8 percent to 15 percent of an alkaline earth metal oxide (e.g., CaO) by weight, 3 percent to 8 percent of an alkali metal oxide (e.g., Na₂O) by weight, 2 percent to 6 percent B₂O₃ by weight, and 0.125 percent to 1.5 percent SO₃ by weight.

The feed composition can optionally include one or more binder resins to aid in forming agglomerates that are robust enough to be conveyed into the furnace. Such binder resins are generally known to those skilled in the art. Examples of suitable binder resins are PVA resins (e.g., polyvinylaclohol), polyvinylbutyral resins, cellulosic or lignin based resins (e.g., Na-carboxymethyl-cellulose, methylcellulose; methylethylcellulose or hydroxypropylcellulose, lignosulfates), polyalkylencarbonate resins (e.g., polypropylenecarbonate), natural gums (e.g., Xanthan gum, gum Arabic), polysaccarides (e.g., starch, modified starch, dextrin), alginates (e.g., sodium or ammonium alginate), glycols (e.g., polyethylene glycol) or waxes (e.g., paraffin, polyethylene wax). Instead of a binder resin, it is also possible to use one or more inorganic binder systems, such as gypsum, salts, soluble silicates or polyphosphazenes.

Further additives of the agglomerate may comprise fluxing agents, glass formers and/or network modifiers. These include, but are not limited to, CaF₂, MgO, BaO, Li₂O, ZnO, B₂O₃, P₂O₅, ZnO, CaO, Na₂O, Al₂O₃ and SiO₂ and combinations with various chemical blowing agents.

In a further embodiment, the feed comprises an agglomerate comprising a natural glassy mineral (e.g. perlite) and optionally a glass composition according to an above embodiment. The ratio of natural glassy mineral to the synthetic glass can vary from 100:0 to 1:99 in parts by weight.

In some embodiments, the glass composition is milled and classified to produce feed of suitable particle size for forming hollow glass microspheres of the desired size. Methods that are suitable for milling the powder include, for example, milling using a bead or ball mill, attritor mill, roll mill, disc mill, jet mill, or combination thereof. For example, to prepare feed of suitable particle size for forming glass microspheres, the powder may be coarsely milled (for example, crushed) using a disc mill, and subsequently finely milled using a jet mill. Jet mills are generally of three types: spiral jet mills, fluidized-bed jet mills, and opposed jet mills, although other types may also be used.

In a preferred embodiment, the blowing agent is a chemical blowing agent that liberates at high temperatures a blowing gas by one or more of combustion, thermal decomposition, or gasification. Preferably, at least one of the products liberated from the chemical blowing agent is not water. The chemical blowing agent can be comprised of, for example, elemental sulfur or compounds containing sulfur and oxygen, such as sulfate or sulfite. Specific examples of useful sulfates include metal sulfates (e.g. zinc sulfate, sodium sulfate, potassium sulfate, lithium sulfate, rubidium sulfate, magnesium sulfate, calcium sulfate, barium sulfate, and lead sulfate). Such blowing agents can be present in an amount of 0.01 percent to 5 percent, or 0.05 percent to 3 percent, or 0.1 percent to 2 percent by weight based on the total weight of the feed composition.

In the exemplary feed compositions, sulfur (presumably combined with oxygen) serves as a blowing agent that, upon heating, causes expansion of molten powder particles to form hollow glass microspheres. By controlling the amount of sulfur in the feed, the amount and length of heating to which the feed is exposed, the mean particle size, and the rate at which particles are fed through the furnace, the amount of expansion of the feed particles can typically be controlled to provide glass microspheres of a selected density. Although the powder generally includes sulfur within a range of 0.005 to 0.7 weight percent, more typically, the sulfur content of the feed composition is in a range of from 0.01 to 0.64 percent by weight, or in a range of from 0.05 to 0.5 percent by weight, based on the total weight of the feed composition.

Other blowing agents, such as CO₂, O₂, or N₂ may be included in addition to sulfur oxides. O₂ in particular is commonly present as a residue from the sulfate ion. CO₂ might be generated from carbonates and hydrogencarbonates or from carbon containing compositions under oxidative conditions in the glass melt and N₂ could be borne from nitrates or nitrites.

The chemical blowing agent preferably has a decomposition temperature of at least 500° C., at least 650° C., at least 800° C., at least 900° C., or at least 1200° C. Optionally, the chemical blowing agent has a decomposition temperature of at most 2000° C., at most 1850° C., at most 1700° C., at most 1600° C., or at most 1500° C.

To obtain consistently sized and shaped HGMs, it is generally desirable for the chemical blowing agent to be entrained directly in the individual grains of the glass powder. Alternatively, the feed composition could instead be comprised of agglomerates of a mixture of glass powder and one or more chemical blowing agents. In this case, the entrainment of the chemical blowing agent is based on the granulated particles being heterogeneously mixed with the glass powder in the agglomerates.

Water, if present, can function as a blowing agent when heated to suitably high temperatures. Where a chemical blowing agent is used, any entrained water can concurrently expand the glass powder to form mono-cellular or multicellular HGMs as it passes through the furnace. Since this introduces another variable into the manufacturing process, it can be advantageous for the feed composition to contain little or no entrained water, or other volatiles.

The glass powder of the feed composition can have a median particle diameter of at least 5 micrometers, at least 10 micrometers, at least 15 micrometers, at least 20 micrometers, or at least 25 micrometers. The glass powder can have a median particle diameter of at most 200 micrometers, at most 150 micrometers, at most 100 micrometers, at most 85 micrometers, or at most 65 micrometers.

In some embodiments, the glass powder of the feed composition has a D₉₀/D₅₀ particle size ratio of at least 1.2, at least 1.5, at most 2, at least 2.3, or at least 2.5. On the upper end, the glass powder of the feed composition can have a D₉₀/D₅₀ particle size ratio of at most 3.5, at most 3.2, at most 3, at most 2.8, or at most 2.5.

The feed composition may further include any of a number of additional additives. For example, the feed composition can optionally include one or more natural glassy minerals which may be thermally expandable. The one or more natural glassy minerals may be comprised in discrete particles that are heterogeneously mixed with the glass powder or comprised in the agglomerates.

The natural glassy minerals can be present in an amount of at least 1 percent, at least 5 percent, at least 10 percent, at least 20 percent, or at least 50 percent by weight, based on the overall weight of the feed composition. In another embodiment, the natural glassy minerals can be present in an amount of at most 100 percent, at most 95 percent, at most 80 percent, at most 70 percent, at most 60 percent, or at most 50 percent by weight, based on the overall weight of the feed composition.

In some embodiments, the agglomerates are characterized by a median agglomerate diameter falling within the same ranges as those described earlier with respect to the particle diameters D₅₀ of glass powders used in the feed composition. Further aspects of useful agglomerates are described, for example, in U.S. Patent Publication No. 2013/344337 (Qi et al.).

### Methods of Manufacture

Furnaces useful in the manufacture of HGMs are vertically-aligned and include a series of individually-adjustable heating zones. Examples of such furnaces include, but are not limited to, those described in U.S. Patent Publication No. 2014/0291582 (Brunnmair) and European Patent Publication Nos. 2,708,517 (Brunnmair) and 2,876,398 (Brunnmair).

In an exemplary method, the feed composition, comprised of a glass powder and chemical blowing agent entrained in the glass powder, is introduced into an opening at a first end of the furnace and the glass powder passed through the series of heating zones under the force of gravity. Within at least one heating zone, the glass powder is heated to a forming temperature at which the grains of the glass powder are sufficiently softened to enable expansion.

Efficiency in the manufacturing process can be improved by providing faster and more uniform heat transfer from the furnace to the feed composition. One way to accomplish this is by dispersing the feed composition into a multiplicity of fine, discrete particles prior to significantly heating the feed composition within the furnace. In preferred embodiments, such dispersion occurs prior to introduction of the feed composition into the furnace. As a result of more uniform separation between the particles, the glass can be more uniformly heated and expanded, potentially providing for HGMs of having more uniform size, wall thickness, and reduced defects.

Dispersion of the feed composition can be achieved, for example, by directing the feed composition into the opening of the furnace in a curtain configuration. In this configuration, the feed composition is metered using a screw-type feeder and then conveyed along a surface that spreads the flow of particles along a straight or curved line prior to its introduction into the furnace. In a preferred embodiment, the curtain is positioned to promote even distribution of particles along the transverse cross-sectional plane of the furnace.

Alternatively, the feed composition can be dispersed as it enters the furnace by using an injection process, such as by injecting the composition through a constricted nozzle. The constriction induces the feed composition to exit the nozzle in a spray pattern, analogous to that produced by an aerosol spray can. The configuration of the constricted nozzle is not particularly limited and could be, for example, an elongated slit or a circular aperture.

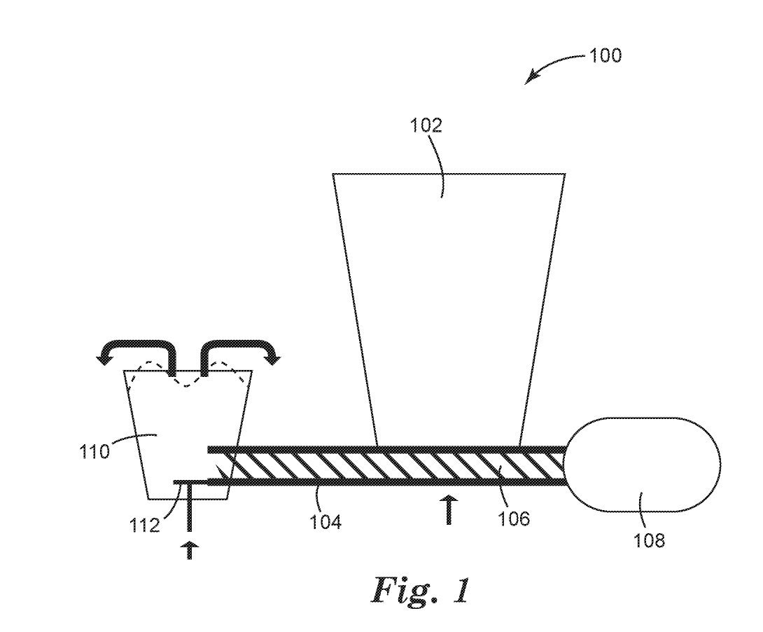

As a further option, the feed composition can be introduced into the furnace as a fluidized bed of particles. An exemplary feeding system is shown in FIG. 1 and hereinafter referred to by numeral 100. Feeding system 100, as shown, includes a feed hub 102 in which a feed composition is received. The feed composition is fed by gravity through a port into a barrel 104 containing a screw 106 rotated by a motor 108. As the screw 106 rotates, the feed composition is continuously conveyed into a feed pipe 110 having a distributor plate 112 affixed to the bottom of the feed pipe 110. The distributor plate 112 injects a carrier gas through a plurality of tiny apertures into a bed of the feed composition to create a fluidized bed which overflows the feed pipe 110 as shown and enters the furnace below it (not visible in FIG. 1) in fluidized form.

Any known carrier gas may be used to fluidize the feed composition, convey the feed composition through the furnace, or both. A common carrier gas is ambient air, which is also the most cost effective. In some applications, however, it may be desirable to use dried air to enhance powder flowability, an inert gas such as helium, argon or nitrogen, or a gas with elevated thermal conductivity such as helium. A carrier gas that is oxygen-starved or oxygen-rich can also be used to change the glass redox reaction for certain glass compositions or to burn some organic components in the feed composition. Such gases may contain, for example, 15-40 percent oxygen by weight. Optionally, the feed composition is preheated before it enters the furnace. Pre-heating the feed composition can significantly reduce the residence time required for the glass powder and any blowing agents to reach the proper forming temperature for HGM production. This in turn can allow for a reduction in the number of heating zones and consequently reduce the length of the furnace without compromising the efficiency of the process or quality of the end product. Especially at higher forming temperatures, pre-heating can significantly increase the productivity of the furnace in terms of output of product per hour.

The feed composition can be pre-heated, for example, to a temperature of at least 30° C., at least 40° C., at least 50° C., at least 75° C., or at least 100° C. In the same or alternative embodiments, the feed composition is pre-heated to a temperature of at most 550° C., at most 500° C., at most 450° C., at most 425° C., or at most 400° C.

Upon entry into the furnace, the feed composition can be conveyed through the series of heating zones by gravity, forced air flow, pressure differences within the furnace, and combinations thereof.

In exemplary embodiments, pressure differences along the length of the furnace can be created by applying a positive pressure at one end. This can be done, for example, by blowing feed into the furnace. Pressure differences along the length of the furnace can also be created by applying a negative pressure at the other end, for example, by passing the stream of air that transports the formed product to a collection system through a restricted (more narrow) section in the product collection system. The acceleration of the gas stream in the restricted section causes a drop in pressure according to the Venturi effect. A negative pressure difference can help ensure that even smaller and more buoyant particles in the feed composition do not remain too long in the furnace and overheat.

The absolute pressure differential between the top and bottom ends of the furnace can be at least 0.01 kPa. The absolute pressure differential could be at most 10 kPa.

The velocity of the gas stream which may be upwards or downwards is in the range of 0.1 to 10 m/s, preferably from 0.5 to 5 m/s.

While overheating as a result of excessive residence time is undesirable, insufficient residence time can also be a problem. Where high forming temperatures are required, it may be necessary to extend the residence time to provide sufficient heat transfer. While this could be addressed in a gravity-fed system by increasing the number heating zones, extending the length of the furnace can be expensive and precluded by space limitations. In these cases, it may be beneficial to counteract the force of gravity by reversing the flow of the carrier gas such that the feed compositions travels more slowly through the heating zones.

Another way of engineering the flow pattern is to tightly close the top of the furnace and introduce the feed from the top, e.g., using a paddle wheel dosing system. The product is collected at the bottom using a negative pressure collection system using the Venturi effect, as described above. In the case of a completely tight furnace, the flow pattern in the furnace is governed only by convection. By implementing openings at the top or at the walls of the furnace which ideally may be controlled by valves the flow pattern may be engineered in such a way that feed is prevented from sticking to the furnace wall and simultaneously transported though the furnace with a narrow residence time distribution.

Depending on the flow pattern desired, the entrance of the furnace in which the feed composition is introduced can be located either on the top or the bottom of the vertically-aligned furnace. In the former case, gravity acts to accelerate the descent of the feed composition through the heating zones; in the latter case, gravity acts to slow the ascent of the feed composition through the heating zones.

In one advantageous configuration, the feed is introduced at the bottom of the furnace applying a gas flow from the bottom to the top of the furnace, where the flow pattern is tailored such that for each feed particle or agglomerate, depending on its size, an equilibrium of the forces is obtained—that is, the feed particle or agglomerate is transported to a specific height and is only conveyed further to the top after the feed has been expanded resulting in a larger projected area. This can prevent small feed particles or agglomerates from being overheated while enabling larger ones to have a longer residence time and absorb enough energy to be expanded.

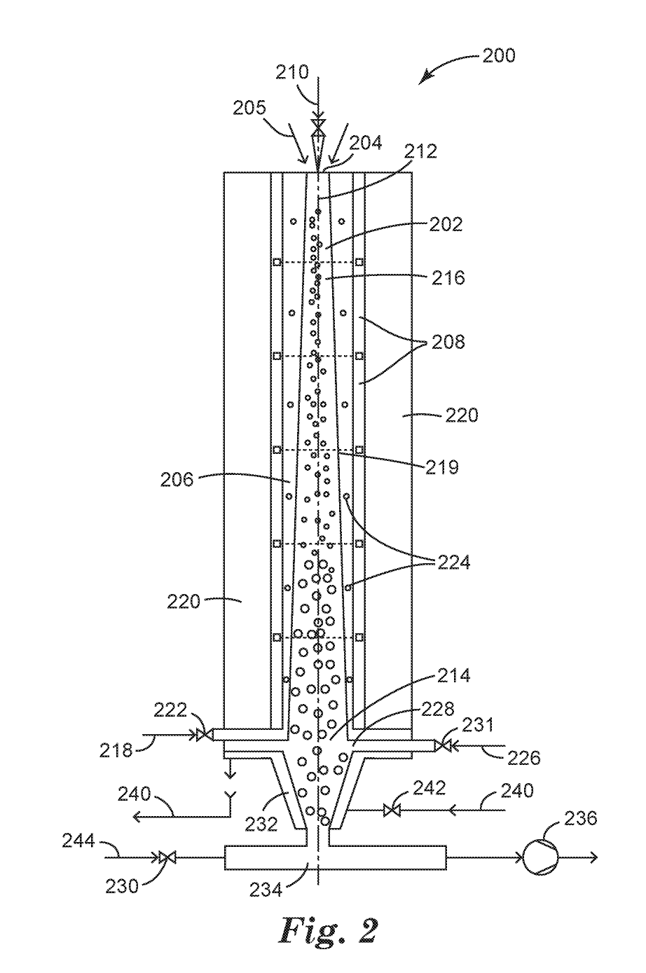

Pressure differences can also be induced by changing the cross-sectional area of the furnace along its length to create volumetric expansion or contraction of the carrier gas as it passes through the furnace. In either instance, there will be a natural change in pressure that results from heating (or cooling) of the carrier gas surrounding the feed composition. As disclosed in U.S. Publication No. 2014/0291582 (Brunnmair) and as shown in the furnace of FIG. 2, the cross-sectional area of the furnace can be expanded to compensate for increases in flow velocity that would otherwise occur as a result of heat-induced expansion of the carrier gas.

FIG. 2 provides a schematic of an exemplary furnace 200, more fully described in U.S. Patent Publication 2014/0291582 (Brunnmair), suitable for making HGMs according to the provided methods. The furnace 200, as shown, comprises a vertically extending furnace shaft 202 having a feed opening 204 at its top end for receiving the feed composition.

The furnace 200 is segmented along its length into six discrete heating zones 206 (separated in FIG. 2 by dashed lines), each having one or more corresponding heating elements 208. The heating elements 208 heat the feed composition 210 as it descends through the furnace shaft 202. In this embodiment, the heating elements 208 are arranged symmetrically with respect to a plane extending through a central axis 212 of the furnace shaft 202. The heating elements 208 preferably use electrical resistive heating elements but may also be gas-operated, if desired. The heating elements 208 can be configured for supplying heat by heat radiation, heat convection, or a combination thereof.

Using electrical resistive heating, it is possible for the series of heating zones to operate at an equilibrium energy consumption of at most 5 kW-h, at most 4 kW-h, at most 3 kW-h, at most 2.5 kW-h, or at most 2 kW-h per kilogram of hollow glass microspheres obtained.

The feeding of the feed composition 210 into the furnace 200 through the feed opening 204 may take place using the metered feeding system 100 of FIG. 1 or, alternatively, any other known feed mechanism.

The feed composition 210 falls from the feed opening 204 along the furnace shaft 202 to a discharge opening 214 at the bottom end of the furnace 200 or the furnace shaft 202. The travel of the feed composition 210, on a macroscopic scale, can be guided by the flow of a first process air 205. As mentioned previously, gases other than air could also be advantageously used.

In the embodiment shown, the width of the furnace shaft 202 (i.e., the transverse cross-section of the furnace shaft 202 normal to the central axis 212) increases from the feed opening 204 to the discharge opening 214. Here, this widening occurs continually, so that the cross-section of the furnace shaft 202 has a generally conical shape. It is understood that the changes in cross-sectional area could, alternatively, change in a discontinuous fashion and the cross-sectional area need not be monotonically increasing. The cross-section of the furnace shaft 202 normal to the falling direction could also have the shape of a rectangle, ellipse, or any other known shape.

Optionally and as shown, the furnace shaft 202 has an inner surface 219 defined by a heat-resistant fabric 216. The heat-resistant fabric 216 is preferably air-permeable, allowing for a second process air 218 to be injected through the fabric 216 toward the central axis 212 of the furnace shaft 202, as shown, to counteract caking of the heated feed composition 210 on the inner surface 219 of the furnace shaft 202. The second process air 218 is injected into the intermediate space between the furnace shaft 202 or its inner surface 219 and an outer heat insulation 220 of the furnace 200 which at least partially extends around the heating elements 208 as shown. The flow rate of the second process air 218 can be controlled using a valve 222 which is preferably controllable.

Temperature sensors 224 can be advantageously disposed within the fabric 216. The temperature sensors 224 are arranged at a various positions vertically spaced apart from each other, where at least one temperature sensor 224 is located in each of the six heating zones 206. The temperature of the feed composition 210 in a given heating zone 206 can be determined based on the temperature measured by its associated temperature sensor 224.

The heating elements 208 and the temperature sensors 224 can be connected to a computer, which can determine the region in the furnace shaft 202 where expansion of the feed composition 210 occurs based on the temperature data.

Expansion can occur when the glass powder reaches its forming temperature, the temperature at which the glass powder begins to plastically deform and flow. In some embodiments, the forming temperature of the feed composition is at least 700° C., at least 1000° C., at least 1100° C., at least 1200° C., at least 1300° C., at least 1400° C., or at least 1500° C. In some embodiments, the forming temperature is at most 1000° C., at most 1250° C., at most 1300° C., at most 1350° C., at most 1400° C., or at most 1450° C.

Optionally, the forming temperature corresponds to a glass melt viscosity that enables facile, yet controlled, expansion of the glass composition when the blowing agent is activated. The melt viscosity can be, for example, at least 10 Pa-s, at least 50 Pa-s, at least 80 Pa-s, or at least 100 Pa-s. The melt viscosity can be, for example, at most 100 Pa-s, at most 320 Pa-s, or at most 1000 Pa-s.

In preferred embodiments, the computer executes a feedback loop that enables real-time adjustment of temperature within the individually-controllable heating zones of the furnace during the manufacturing process. Within this feedback loop, the computer can detect reductions in temperature that result from the isenthalpic expansion process of the feed composition 210, the surface of the glass powder in the feed composition 210 softens and then expands as the chemical blowing agent decomposes within the glass powder.

The blowing agent is preferably activated after the glass powder has softened to properly form the hollow glass microspheres. To facilitate this, one can pair the glass composition with a blowing agent that has a decomposition temperature somewhat higher than that of the softening point of the glass.

Advantageously, the computer can respond by adjusting the power level of one or more of the heating elements 208 located downstream from the region of the temperature drop to preclude further increase in the temperature of the now expanded feed composition 210, or HGMs, and prevent overheating.

The thermal treatment of the newly formed HGMs influences the ultimate structure obtained. To more rapidly cool the HGMs, a cooling air 226 can be injected into the flow of HGMs as it is discharged from the furnace 200. An outflow opening 228 for the cooling air 226 is further provided, as shown, in the region of the discharge opening 214. The quantity of cooling air 226 can be governed by a valve 231, as shown. The cooling air produces a cooling of the HGMs to a temperature below 100° C., or preferably below 80° C.

The HGMs obtained can finally be drawn through a chute 232 located downstream from the discharge opening 214 into a collection vessel 234, optionally with the assistance of a vacuum pump 236 as shown. Optionally and as shown, the chute 232 is cooled by water 240 whose flow is controllable by valve 242. The flow of HGMs obtained can be adjusted by controlling the velocity of cool air 244, which produces negative pressure relative to the furnace shaft 202. The flow of the cool air 244 can be governed by valve 230, as shown.

### Hollow Glass Microspheres

The HGMs obtained using the aforementioned methods may be comprised of both mono-cellular (single cell) and multi-cellular species. It is preferable, however, that at least 50 percent, at least 55 percent, at least 60 percent, at least 65 percent, or at least 70 percent, of the hollow glass microspheres are mono-cellular.

Ideally, the HGMs produced are of the “closed cell” type, meaning that the void or voids within each microsphere do not communicate with the space around the microsphere. In preferred embodiments, at least 60 percent, at least 65 percent, at least 70 percent, at least 75 percent, or at least 80 percent of the hollow glass microspheres are closed cell.

In some embodiments, the HGMs have a median particle diameter D₅₀ of at least 5 micrometers, at least 7.5 micrometers, at least 10 micrometers, at least 15 micrometers, or at least 20 micrometers. In some embodiments, the HGMs have a median particle diameter D₅₀ of at most 500 micrometers, at most 400 micrometers, at most 300 micrometers, at most 200 micrometers, at most 150 micrometers, at most 100 micrometers, at most 80 micrometers, or at most 65 micrometers. In contrast to existing processes, the described method can be suited to make large HGM with a D₅₀ of 100 to 500 micrometers or 200 to 400 micrometers.

The size distribution of the HGMs made using the provided processes may be Gaussian, normal, or non-normal. Non-normal distributions may be mono-modal or multi-modal (e.g., bimodal). The hollow glass microspheres can have a D₉₀/D₅₀ particle size ratio of at least 1.2, at least 1.5, at least 2, at least 2.3, or at least 2.5. The hollow glass microspheres can have a D₉₀/D₅₀ particle size ratio of at most 3.5, at most 3.2, at most 3, at most 2.8, or at most 2.5.

The provided methods can be used to make HGMs that display a wide range of densities. The HGMs can have, for example, an average density of at least 0.1 g/cm³, at least 0.11 g/cm³, at least 0.12 g/cm³, at least 0.13 g/cm³, or at least 0.15 g/cm³. The upper limit of density is only limited by the density of the constituent glass powder. In exemplary embodiments, the HGMs could have an average density of at most 1 g/cm³, at most 0.85 g/cm³, at most 0.7 g/cm³, at most 0.65 g/cm³, or at most 0.6 g/cm³.

Depending on the density and the nature of the glass material used to make the HGMs, the provided HGMs can display an average collapse strength of at least 1.5 MPa, at least 3 MPa, at least 6 MPa, at least 12 MPa, at least 24 MPa. Further, the HGMs made according to the provided methods can display an average collapse strength of up to 200 MPa, up to 150 MPa, up to 100 MPa, up to 50 MPa, or up to 25 MPa.

Further non-limiting embodiments are enumerated as follows:

1. A method of manufacturing hollow glass microspheres comprising: introducing a feed composition comprising a glass powder and a blowing agent entrained in the glass powder into an opening at a first end of a vertically-aligned furnace, whereby the glass powder passes through a series of individually-adjustable heating zones located within the furnace; within at least one heating zone, heating the glass powder to a forming temperature at which the glass powder is softened; thereafter thermally activating the chemical blowing agent to expand the softened glass powder in the feed composition and to obtain the hollow glass microspheres; and discharging the hollow glass microspheres through an opening at a second end of the furnace located distal to the first end.
2. A method of manufacturing hollow glass microspheres comprising: introducing a feed composition comprising an agglomerate of glass powder and a chemical blowing agent into an opening at a first end of a vertically-aligned furnace, whereby the agglomerate passes through a series of individually-adjustable heating zones located within the furnace; within at least one heating zone, heating the agglomerate to a forming temperature at which the glass powder is softened; thereafter thermally activating the chemical blowing agent to expand the softened glass powder in the feed composition and to obtain the hollow glass microspheres; and discharging the hollow glass microspheres through an opening at a second end of the furnace located distal to the first end.
3. The method of embodiment 1 or 2, wherein the series of heating zones is characterized by a temperature profile and further comprising adjusting the temperature profile in response to measured temperature fluctuations in the feed composition induced by expansion of the softened glass powder.
4. The method of any one of embodiments 1-3, wherein the forming temperature is from 700° C. to 1450° C.
5. The method of embodiment 4, wherein the forming temperature is from 800° C. to 1400° C.
6. The method of embodiment 5, wherein the forming temperature is from 900° C. to 1350° C.
7. The method of any one of embodiments 1-6, wherein the softened glass powder has a melt viscosity of at least 10 Pa-s at the forming temperature.
8. The method of embodiment 7, wherein the softened glass powder has a melt viscosity of at least 100 Pa-s at the forming temperature.
9. The method of embodiment 8, wherein the softened glass powder has a melt viscosity of at most 1000 Pa-s at the forming temperature.
10. The method of any one of embodiments 1-9, wherein introducing the feed composition comprises introducing the feed composition in a curtain configuration.
11. The method of any one of embodiments 1-9, wherein introducing the feed composition comprises injecting the feed composition through a constricted nozzle.
12. The method of embodiment 11, wherein the constricted nozzle comprises a slit.
13. The method of embodiment 11, wherein the constricted nozzle comprises a generally circular aperture.
14. The method of any one of embodiments 1-9, wherein introducing the feed composition comprises forming a fluidized particle bed.
15. The method of any one of embodiments 1-14, further comprising pre-heating the feed composition to a pre-heating temperature of from 30° C. to 550° C. prior to introducing the feed composition.
16. The method of embodiment 15, further comprising pre-heating the feed composition to a pre-heating temperature of from 50° C. to 450° C. prior to introducing the feed composition.
17. The method of embodiment 16, further comprising pre-heating the feed composition to a pre-heating temperature of from 100° C. to 400° C. prior to introducing the feed composition.
18. The method of any one of embodiments 1-17, further comprising creating a pressure differential between the first and second ends of the furnace.
19. The method of embodiment 17, wherein the absolute pressure differential is from 0.01 kPa to 10 kPa.
20. The method of embodiment 1-19, wherein the feed composition is conveyed by a gas stream having a velocity of from 0.1 m/s to 10 m/s.
21. The method of embodiment 20, wherein the gas stream has a velocity of from 0.5 m/s to 5 m/s.
22. The method of any one of embodiments 1-21, wherein the first and second ends of the furnace correspond to top and bottom ends of the furnace, respectively, and whereby gravity accelerates descent of the feed composition through the series of heating zones.
23. The method of any one of embodiments 1-21, wherein the first and second ends of the furnace correspond to bottom and top ends of the furnace, respectively, and whereby gravity slows ascent of the feed composition through the series of heating zones.
24. The method of any one of embodiments 1-23, further comprising fluidizing the feed composition in a carrier gas.
25. The method of embodiment 24, wherein the carrier gas comprises dry air.
26. The method of embodiment 24, wherein the carrier gas is selected from the group consisting of: argon, nitrogen, oxygen, and mixtures thereof.
27. The method of embodiment 26, wherein the carrier gas comprises 15 wt % to 40 wt % oxygen.
28. The method of any one of embodiments 1-27, wherein the series of heating zones operates at an equilibrium energy consumption of at most 5 kW-h per kilogram of hollow glass microspheres obtained.
29. The method of embodiment 28, wherein the series of heating zones operates at an equilibrium energy consumption of at most 3 kW-h per kilogram of hollow glass microspheres obtained.
30. The method of embodiment 29, wherein the series of heating zones operates at an equilibrium energy consumption of at most 2 kW-h per kilogram of hollow glass microspheres obtained.
31. The method of any one of embodiments 1-30, wherein the feed composition comprises: (a) 50-90 wt % by weight of SiO₂; (b) 2-20 wt % of alkali metal oxides; (c) 1-30 wt % of B₂O₃; (d) 0.005-0.5 wt % of sulfur; (e) 0-25 wt % divalent metal oxides; (f) 0-10 wt % of tetravalent metal oxides other than SiO₂; (g) 0-20 wt % of trivalent metal oxides; (h) 0-10 wt % of oxides of pentavalent atoms; and (i) 0-5 wt % fluorine.
32. The method of any one of embodiments 1-31, wherein at least 90% of the feed composition consists essentially of: 70-80 wt % SiO₂; 8-15 wt % R¹O; 3-8 wt % R²₂O; and 2-6 wt % B₂O₃, wherein R¹ and R² are metals having the indicated valence.
33. The method of embodiment 32, wherein the feed composition has an alkaline earth metal oxide:alkali metal oxide weight ratio of from 1.2 to 3.
34. The method of embodiment 32 or 33, wherein at least 90% of the feed composition consists essentially of: 70-80 wt % SiO₂; 8-15 wt % CaO; 3-8 wt % Na2O; and 2-6 wt % B₂O₃.
35. The method of any one of embodiments 1-34, wherein the feed composition is essentially free of entrained water.
36. The method of any one of embodiments 1-35, wherein the glass powder has a median particle diameter D50 of from 5 micrometers to 100 micrometers.
37. The method of embodiment 36, wherein the glass powder has a median particle diameter D₅₀ of from 5 micrometers to 50 micrometers.
38. The method of embodiment 37, wherein the glass powder has a median particle diameter D₅₀ of from 5 micrometers to 40 micrometers.
39. The method of any one of embodiments 1-38, wherein the blowing agent comprises a sulfate, sulfite, elemental sulfur, or mixture thereof.
40. The method of any one of embodiments 1-39, wherein the blowing agent has a decomposition temperature of from 700° C. to 1500° C.
41. The method of embodiment 40, wherein the blowing agent has a decomposition temperature of from 800° C. to 1450° C.
42. The method of embodiment 41, wherein the blowing agent has a decomposition temperature of from 900° C. to 1350° C.
43. The method of any one of embodiments 1-42, wherein the blowing agent is entrained directly in the glass powder.
44. The method of any one of embodiments 1-43, wherein the feed composition comprises agglomerates of the glass powder and granulated particles, the blowing agent being entrained in the granulated particles.
45. The method of any one of embodiments 1-44, wherein the glass powder of the feed composition has a D₉₀/D₅₀ particle size ratio of from 1.2 to 3.5.
46. The method of embodiment 44, wherein the glass powder of the feed composition has a D₉₀/D₅₀ particle size ratio of from 1.5 to 3.2.
47. The method of embodiment 45, wherein the glass powder of the feed composition has a D₉₀/D50 particle size ratio of from 2 to 3.
48. The method of any one of embodiments 1-47, wherein the feed composition further comprises one or more natural glassy minerals.
49. The method of embodiment 48, wherein the one or more natural glassy minerals are thermally expandable.
50. The method of embodiment 48, wherein the one or more minerals are comprised in discrete particles heterogeneously mixed with the glass powder.
51. The method of any one of embodiments 48-50, wherein the one or more natural glassy minerals are present in an amount of from 1 percent to 95 percent by weight based on the overall weight of the feed composition.
52. The method of embodiment 51, wherein the one or more natural glassy minerals are present in an amount of from 10 percent to 70 percent by weight based on the overall weight of the feed composition.
53. The method of embodiment 52, wherein the one or more natural glassy minerals are present in an amount of from 20 percent to 50 percent by weight based on the overall weight of the feed composition.
54. The method of any one of embodiments 1-53, wherein at least 50 percent of the hollow glass microspheres are monocellular.
55. The method of embodiment 54, wherein at least 60 percent of the hollow glass microspheres are monocellular.
56. The method of embodiment 55, wherein at least 70 percent of the hollow glass microspheres are monocellular.
57. The method of any one of embodiments 1-56, wherein at least 60 percent of the hollow glass microspheres are closed cell.
58. The method of embodiment 57, wherein at least 70 percent of the hollow glass microspheres are closed cell.
59. The method of embodiment 58, wherein at least 80 percent of the hollow glass microspheres are closed cell.
60. The method of any one of embodiments 1-59, wherein the hollow glass microspheres have a median particle diameter D₅₀ of from 5 micrometers to 500 micrometers.
61. The method of embodiment 60, wherein the hollow glass microspheres have a median particle diameter D₅₀ of from 10 micrometers to 400 micrometers.
62. The method of embodiment 61, wherein the hollow glass microspheres have a median particle diameter D₅₀ of from 20 micrometers to 65 micrometers.
63. The method of any one of embodiments 1-62, wherein the hollow glass microspheres have a D₉₀/D₅₀ particle size ratio of from 1.2 to 3.5.
64. The method of embodiment 63, wherein the hollow glass microspheres have a D₉₀/D₅₀ particle size ratio of from 1.5 to 3.2.
65. The method of embodiment 64, wherein the hollow glass microspheres have a D₉₀/D₅₀ particle size ratio of from 2 to 3.
66. The method of any one of embodiments 1-65, wherein the hollow glass microspheres have a generally monomodal particle size distribution.
67. The method of any one of embodiments 1-66, wherein the hollow glass microspheres have an average density of from 0.1 g/cm³ to 1 g/cm³.
68. The method of embodiment 67, wherein the hollow glass microspheres have an average density of from 0.12 g/cm³ to 0.7 g/cm³.
69. The method of embodiment 68, wherein the hollow glass microspheres have an average density of from 0.15 g/cm³ to 0.6 g/cm³.
70. The method of any one of embodiments 1-69, wherein the hollow glass microspheres display an average collapse strength of at least 1.5 MPa.
71. The method of embodiment 70, wherein the hollow glass microspheres display an average collapse strength of at least 6 MPa.
72. The method of embodiment 71, wherein the hollow glass microspheres display an average collapse strength of at least 24 MPa.
73. A method of making hollow glass microspheres comprising: introducing a feed composition comprising an agglomerate comprising a natural glassy material and a chemical blowing agent into an opening at a first end of a vertically-aligned furnace, whereby the agglomerate passes through a series of individually-adjustable heating zones located within the furnace; within at least one heating zone, heating the agglomerate to a forming temperature at which the natural glassy material is softened; thereafter thermally activating the chemical blowing agent to expand the softened natural glassy material in the feed composition and to obtain the hollow glass microspheres; and discharging the hollow glass microspheres through an opening at a second end of the furnace located distal to the first end.
74. The method of embodiment 73, wherein the feed composition further comprises a fluxing agent.
75. A method of manufacturing hollow glass microspheres comprising: introducing a feed composition comprising an agglomerate of: a natural glassy material, blowing agent and additive selected from the group consisting of: fluxing agents, glass formers, network modifiers, and mixtures thereof, into an opening at a first end of a vertically-aligned furnace, whereby the agglomerate passes through a series of individually-adjustable heating zones located within the furnace; within at least one heating zone, heating the agglomerate to a forming temperature at which the natural glassy material is softened; thereafter thermally activating the blowing agent to expand the softened natural glassy material in the feed composition and to obtain the hollow glass microspheres; and discharging the hollow glass microspheres through an opening at a second end of the furnace located distal to the first end.
76. A method of manufacturing hollow glass microspheres comprising: introducing a feed composition comprising an agglomerate of one or more unmelted oxides and a blowing agent into an opening at a first end of a vertically-aligned furnace, whereby the agglomerate passes through a series of individually-adjustable heating zones located within the furnace; within at least one heating zone, heating the agglomerate to a forming temperature to soften the unmelted oxide(s); thereafter thermally activating the blowing agent to expand the softened unmelted oxide(s) in the feed composition and to obtain the hollow glass microspheres; and discharging the hollow glass microspheres through an opening at a second end of the furnace located distal to the first end.
77. The method of embodiment 76, wherein the one or more unmelted oxides comprises a silica, carbonate, or mixture thereof.
78. Hollow glass microspheres made according to the method of any one of embodiments 1-77.
79. The feed composition according any one of embodiments 1-77.

### EXAMPLES

Objects and advantages of this disclosure are further illustrated by the following non-limiting prophetic examples, but the particular materials and amounts thereof recited in these prophetic examples, as well as other conditions and details, should not be construed to unduly limit this disclosure. of the specification are by weight.

### Particle Density Measurement

The average density is measured using a pycnometer according to DIN EN ISO 1183-3. The pycnometer may be obtained, for example, under the trade designation “ACCUPYC 1340 PYCNOMETER” from Micromeritics, Norcross, Georgia. The average density can typically be measured with an accuracy of 0.001 g/cm³. Accordingly, unless otherwise noted or as made clear from the context, each of the density values are reported as true densities (not bulk densities) and reported within an approximate range of error of ±five percent.

### Particle Size Measurement

The particle size distribution and the median size by volume is determined by laser light diffraction by dispersing the hollow glass microspheres in deaerated, deionized water. The median size is also called the D₅₀ size, where 50 percent by volume of the hollow glass microspheres in the distribution are smaller than the indicated size. The glass powder and the HGM obtained by the disclosed process are not monodisperse, so D₅₀ alone is not sufficient to describe the distribution of these different sizes, but it is sufficient for the purpose of this disclosure to describe the particle size distribution by adding also the so called D₁₀ and D₉₀ values, where 10 percent, respectively 90 percent, by volume of the hollow glass microspheres in the distribution are smaller than the indicated size.

Laser light diffraction particle size analyzers are available, for example, under the trade designation “SATURN DIGISIZER MASTERSIZER 2000” from Micromeritics Malvern.

### Strength Testing

The collapse strength of the hollow glass microspheres is measured on a dispersion of the hollow glass microspheres in glycerol using ASTM D3102 -72 “Hydrostatic Collapse Strength of Hollow Glass Microspheres”; with the exception that the sample size (in grams) is equal to 10 times the density of the glass bubbles. Collapse strength can typically be measured with an accuracy of ±five percent. Accordingly, each of the collapse strength values provided above can be ±five percent.

One of the standard tests is to do a floater/sinker test where the bubbles are floated in a flask of water and the floaters are separated from the sinkers.

### Microscopy

Small samples of the product are observed at a magnification of 100-fold using a Phenom G2 scanning electron microscope, available form LOT-Oriel, Darmstadt, Germany.

### Prophetic Example 1

An amorphous glass particle feed (FD1) was prepared as described in Example 5 of U.S. Pat. No. 4,767,726 (Marshall). A total of 5000 kg of this frit was melted, quenched in water, milled and classified, resulting in a particle size distribution of D₉₀=48 micrometers, D₅₀=25 micrometers and D₁₀=8 micrometers.

The feed FD 1 will be fed into a rectangular shaped furnace as schematically drawn in FIG. 2 at a rate of 300 kg/hr. Actual expansion is expected to occur in zone 7, set to 1330° C. The resulting product shall be analyzed for the percentage of expanded HGM, density, particle size distribution and collapse strength.

### Prophetic Example 2

An amorphous glass particle feed (FD2) was prepared according to Example FSC3 of U.S. Patent Publication No. 2006/0122049 (Marshall et al). A total of 1000 kg of this frit was melted, quenched in water, and milled, resulting in an approximate particle size distribution of D₉₀=54.1 micrometers, D₅₀=32.5 micrometers and D₁₀=10.2 micrometers.

The feed FD2 shall be fed into a rectangular shaped furnace as shown in FIG. 2 at a rate of 275 kg/hr. Actual expansion is expected to occur in zone 7, set to 1390° C. The resulting product shall be analyzed for % of expanded HGMs, density, particle size distribution and collapse strength.

### Example 3

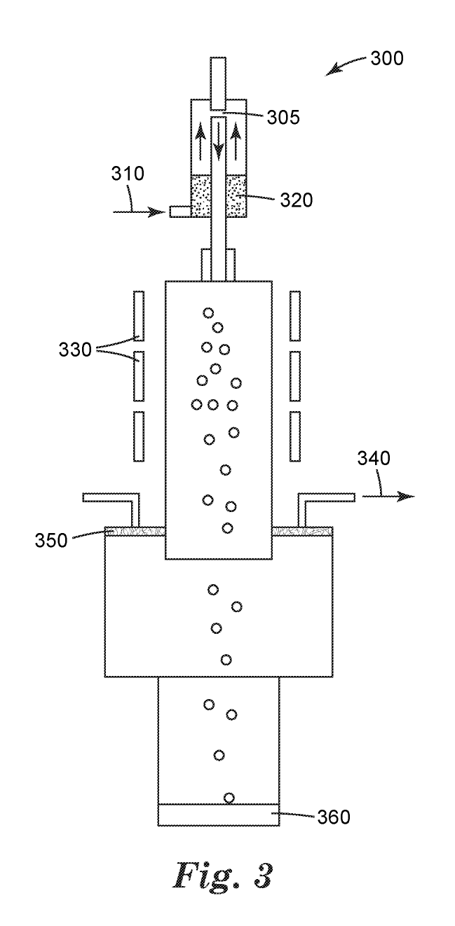

An amorphous glass particle feed (FD1) was prepared as described in Example 5 of U.S. Patent No. 4,767,726 (Marshall) and passed through the furnace schematically shown in FIG. 3. A carrier gas of nitrogen fed at 5 liters per minute was used to introduce the feed composition into the apparatus.

In FIG. 3, a carrier gas is added through carrier gas port 310, which carries feed particles 320 upward to and through opening 305 and subsequently downward (as shown) through apparatus 300 and to the heating zone. Heating elements 330 form the heating zone. Excess gas is removed through exhaust 340 after passing through filter 350. Bubbles are then collected at the bottom end 360 of apparatus 300 as shown.

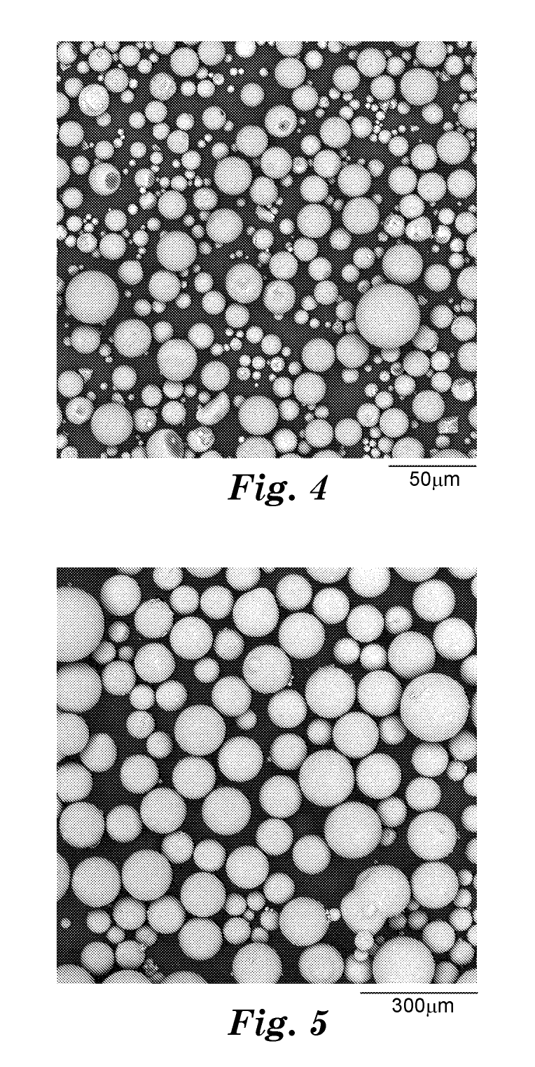

The hottest zone was at 1450° C. The resulting single cellular hollow microspheres had a D₅₀ of ˜30 μm and a density of 1.0844 g/cm³. FIG. 4 is an SEM micrograph of the Example 3 bubbles.

Example 4

Example 4 was prepared in the same manner as Example 3 above, except that an agglomerated glass feed containing 1.5 wt. % blowing agent (Na₂SO₄) was prepared according to Examples A1-15 in WO 2012/134679 Patent Publication. The average particle size of the agglomerates was D₅₀˜30 μm; density: 2.43 g/cm³. This feed was passed through the furnace at a pressure of 0 to −3 mm Hg (−400 Pa) with a N₂-carrier gas stream; the hottest zone was at 1450° C. The resulting hollow microspheres, which are mainly single cellular, had a D₅₀ of ˜100 μm and a density of 0.66 g/cm³. FIG. 5 is an SEM micrograph of the Example 4 bubbles.

Example 5

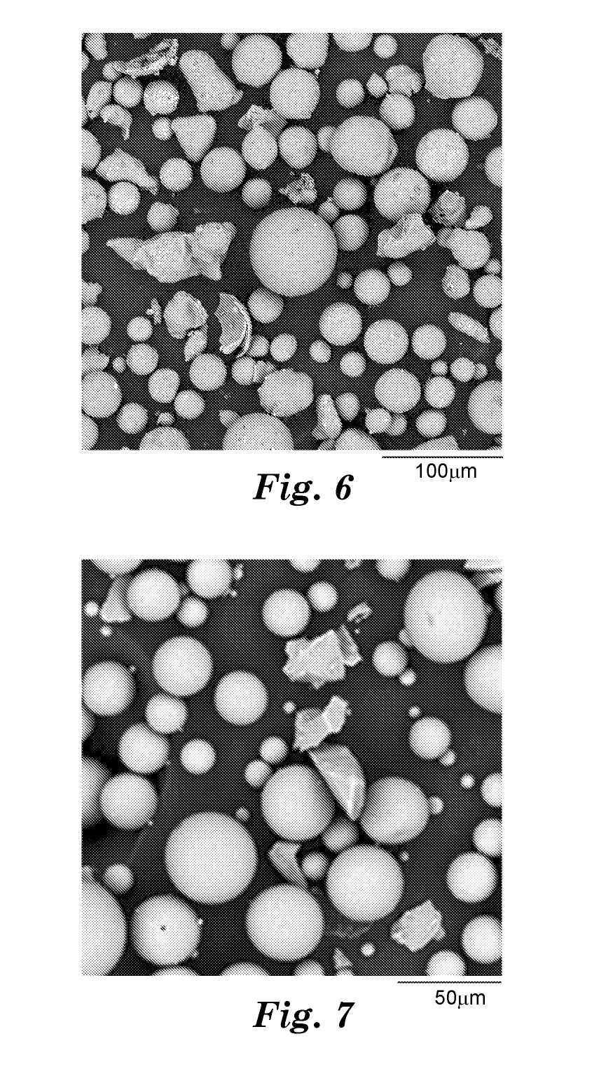

Example 5 was prepared in the same manner as Example 4 above, except that an agglomerated perlite feed made from perlite dust PD1 (a fine dust perlite available commercially as Iperlite BA3). The agglomerated perlite feed was screened through a 105 μm sieve, and contained 0.5 w % of the blowing agent Na₂SO₄. The feed was made according to the procedure for A1-15 in WO 2012/134679 Patent Publication. The agglomerates had a density of 2.15 g/cm³ and were free flowing with an average particle size of D₅₀˜60 μm. The hottest zone in the furnace was 1700° C. The floated hollow microspheres had a D₅₀ of ˜60 μm and a density of 0.8038 g/cm³. It appeared that the majority of bubble were single cell bubbles. FIG. 6 is an SEM micrograph of the Example 5 bubbles.

Example 6

Example 6 was prepared in the same manner as Example 5 above, except that the agglomerated perlite feed was a different batch having higher purity. The agglomerated perlite feed was screened through a 105 μm sieve, and contained 0.5 w % of the flowing agent Na₂SO₄. The agglomerates were free flowing with an average particle size of D₅₀˜50 μm. The floated hollow microspheres had a density of 0.8998 g/cm³. It appeared that the majority of bubble were single cell bubbles. FIG. 7 is an SEM micrograph of the Example 6 bubbles.

Example 7

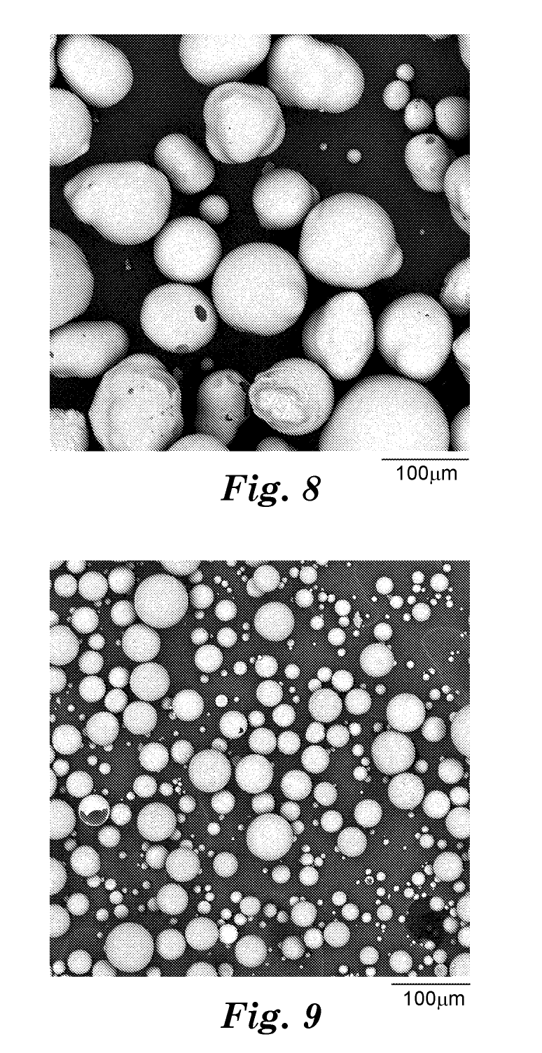

Example 7 was prepared in the same manner as Example 5 above, except that the feed contained additionally 10 wt. % of boric acid as a fluxing agent. The hottest zone in the furnace was 1600° C. The floated hollow microspheres had a D₅₀ of ˜120 μm and a density of 0.6412 g/cm³. It appeared that the bubbles were a mixture of single cell and multi cell bubbles. FIG. 8 is an SEM micrograph of the Example 7 bubbles. It was believed that by adjusting the process parameters such as the hot zone temperature, more single cell bubbles could be produced.

Example 8

Example 8 was prepared in the same manner as Example 3 above, except that an agglomerated oxide feed was used. The agglomerated oxide feed was prepared by wet milling and then spray drying the oxide formulation shown in Table 1, below. The agglomerate oxide particles had a D₅₀ of ˜25 μm. The hottest zone in the furnace was 1450° C. The density of the hollow microspheres was 0.7293 g/cc and D₅₀ of the hollow microspheres was ˜40 μm. FIG. 9 is an SEM micrograph of the Example 8 bubbles.

1-20. (canceled)

21. A method of manufacturing hollow glass microspheres comprising:
introducing a feed composition comprising a glass and a blowing agent into an opening at a first end of a vertically-aligned furnace, whereby the glass passes through a series of individually-adjustable heating zones located within the furnace;
within at least one heating zone, heating the glass to a forming temperature at which the glass is softened;
thereafter thermally activating the blowing agent to expand the softened glass in the feed composition and to obtain the hollow glass microspheres; and
discharging the hollow glass microspheres through an opening at a second end of the furnace located distal to the first end.

22. The method of claim 21, wherein the glass is a glass powder and the blowing agent is entrained in the glass powder.

23. The method of claim 21, wherein the feed composition comprises an agglomerate comprising the glass and the blowing agent, wherein the blowing agent is a chemical blowing agent.

24. The method of claim 23, wherein the glass is a glass powder.

25. The method of claim 23, wherein the glass is a natural glassy material.

26. The method of claim 23, wherein the glass comprises one or more unmelted oxides.

27. The method of claim 21, wherein the feed composition further comprises an additive selected from fluxing agents, glass formers, network modifiers, and mixtures thereof.

28. The method of claim 21, wherein the series of heating zones is characterized by a temperature profile and further comprising adjusting the temperature profile in response to measured temperature fluctuations in the feed composition induced by expansion of the softened glass.

29. The method of claim 21, wherein the forming temperature is from 700° C. to 1450° C.

30. The method of claim 21, wherein introducing the feed composition comprises injecting the feed composition through a constricted nozzle comprising a slit or generally circular aperture.

31. The method of claim 21 wherein introducing the feed composition comprises forming a fluidized particle bed.

32. The method of claim 21, further comprising pre-heating the feed composition to a pre-heating temperature of from 30° C. to 550° C. prior to introducing the feed composition.

33. The method of claim 21, wherein the first and second ends of the furnace correspond to bottom and top ends of the furnace, respectively, and whereby gravity slows ascent of the feed composition through the series of heating zones.

34. The method of claim 21, further comprising fluidizing the feed composition in a carrier gas selected from argon, nitrogen, oxygen, and mixtures thereof.

35. The method of claim 21, wherein the series of heating zones operates at an equilibrium energy consumption of at most 5 kW-h per kilogram of hollow glass microspheres obtained.

36. The method of claim 21, wherein the feed composition comprises:
(a) 50-90 wt % by weight of SiO₂;
(b) 2-20 wt % of alkali metal oxides;
(c) 1-30 wt % of B₂O₃;
(d) 0.005-0.5 wt % of sulfur;
(e) 0-25 wt % divalent metal oxides;
(f) 0-10 wt % of tetravalent metal oxides other than SiO₂;
(g) 0-20 wt % of trivalent metal oxides;
(h) 0-10 wt % of oxides of pentavalent atoms; and
(i) 0-5 wt % fluorine.

37. The method of claim 21, wherein at least 90% of the feed composition consists essentially of:
70-80 wt % SiO₂;
8-15 wt % R¹O;
3-8 wt % R²₂O; and
2-6 wt % B₂O₃, wherein R¹ and R² are metals having the indicated valence.

38. The method of claim 37, wherein the feed composition has an alkaline earth metal oxide:alkali metal oxide weight ratio of from 1.2 to 3.

39. The method of claim 37, wherein at least 90% of the feed composition consists essentially of:
70-80 wt % SiO₂;
8-15 wt % CaO;
3-8 wt % Na₂O; and
2-6 wt % B₂O₃.

40. The method of claim 22, wherein the blowing agent is a chemical blowing agent.

41. The method of claim 21, wherein the blowing agent is a chemical blowing agent and wherein the chemical blowing agent comprises a sulfate, sulfite, elemental sulfur, or mixture thereof.

42. The method of claim 21, wherein the blowing agent has a decomposition temperature of from 700° C. to 1500° C.
